(19) United States
(12) Patent Application Publication
(10) Pub. No.: US 2026/0300633 A1
(43) Pub. Date: Oct. 1, 2026

(54) Method for Controlling a Technical System

(71) Applicant: Robert Bosch GmbH, Stuttgart (DE)

(72) Inventors: Jochen Quante, Ludwigsburg (DE); Thomas Bleile, Stuttgart-Zuffenhausen (DE)

(21) Appl. No.: 19/575,353

(22) Filed: Mar. 23, 2026

(30) Foreign Application Priority Data
Mar. 27, 2025 (DE) 10 2025 111 972.4

(51) Int. Cl. G06F 40/30

(52) U.S. Cl. CPC G06F 40/30

(57) ABSTRACT

A method of controlling a technical system includes (i) providing a textual description of a behavior of a technical system to a large language model (LLM) with the request to output an output having an indication of states of the technical system and an indication of conditions for the states regarding input parameters of the technical system, which indicate for which configuration of the input variables is the technical system in a respective state of the states, (ii) checking whether the output of the LLM satisfies a criterion for completeness and/or consistency and controlling the technical system according to the output, if it meets the criterion, and (iii) in response to the output of the LLM not satisfying the criterion, requesting the LLM one or more times to improve the output until the corrected output satisfies the criterion and controlling the technical system according to the corrected output.

This application claims priority under 35 U.S.C. § 119 to patent application no. DE 10 2025 111 972.4, filed on Mar. 27, 2025 in Germany, the disclosure of which is incorporated herein by reference in its entirety.

The present disclosure relates to methods of controlling a technical system, particularly a robot or vehicle (or components thereof).

### BACKGROUND

Controlling a technical system may be very complex. Accordingly, there are extensive requirements for control software for controlling technical systems so that they accurately map a desired behavior. In particular, control software must completely and consistently reflect a desired behavior, the description of which may at least in part be available only in textual form (and possibly incomplete). However, the complete and consistent implementation of a textual description is difficult because exact algorithms typically require exact formal models. Accordingly, approaches are desirable that ensure a technical system is controlled precisely as desired, even when the desired behavior is described in unstructured form.

### SUMMARY

In accordance with various embodiments, a method of controlling a technical system is described, comprising supplying a textual description of a behavior of a technical system to a large language model (LLM) with the request to output an output including an indication of states of the technical system and an indication of conditions for the states with respect to input parameters of the technical system, which indicate for which configuration of the input variables is the technical system in a respective one of the states, checking whether the output of the LLM satisfies a criterion with regard to completeness and/or consistency and controlling the technical system according to the output, if it meets the criterion, and, in response to the output of the LLM not satisfying the criterion, requesting the LLM one or more times to improve the output until the corrected output satisfies the criterion and controlling the technical system according to the corrected output.

The method described above allows an exact control rule for a technical system (e.g., a vehicle or a robot) to be generated with a textual description as a starting point. In particular, a discrete decision model, such as a state machine or decision tree, may be generated from the output of the LLM that enables effective checking for consistency and/or completeness and precise control. The LLM thus serves as an interface between the description of the desired behavior in natural language and a precise mathematical description of the desired behavior.

The method may also first comprise creating the textual description, e.g., by one or more human users.

Various exemplary embodiments are specified in the following.

Exemplary embodiment 1 is a method used for controlling a technical system, as described above.

Exemplary embodiment 2 is a method according to exemplary embodiment 1, wherein requesting the LLM to correct the output comprises supplying a supplement or change to the textual description of the behavior of the technical system to the large language model (e.g., by a human user).

The review may also lead to the recognition that the textual description is not complete or correct, e.g., in response to the LLM failing to provide a complete or consistent output even upon multiple requests. Then, the textual description may be supplemented and/or corrected to obtain a complete and consistent model for control.

Exemplary embodiment 3 is a method according to exemplary embodiment 2, wherein at least one additional behavioral rule is added as a supplement to the textual description.

For example, the test may determine that the textual description is not complete and, for example, does not describe the behavior (i.e., the state, e.g., the mode of operation) for one or more combinations of input parameter configurations (i.e., alternatives). By supplementing a corresponding behavioral rule, the LLM is enabled to complete its output accordingly.

Exemplary embodiment 4 is a method according to any one of the exemplary embodiments 1 to 3, comprising generating a discrete decision model, which describes the behavior of the technical system, from the large language model output or the corrected large language model output and checking whether the output or the corrected output satisfies the criterion by examining the discrete decision model and controlling the technical system according to the discrete decision model when the output or the corrected output satisfies the criterion.

The output of the LLM is more structured than the textual description. A formal (or mathematical) discrete decision model, such as a decision tree (e.g., a BDD (binary decision diagram)) or state machine, may be generated therefrom. Such a decision model may be efficiently checked for completeness and consistency by mathematical methods. In addition, efficient control is possible on the basis thereof. It is thus achieved that an exact control model is generated from a textual description.

Exemplary embodiment 5 is a method according to any one of the exemplary embodiments 1 to 4, wherein requesting the LLM to correct the output comprises requesting the LLM to supplement, for one or more configurations of the input variables for which its output does not indicate a state in which the technical system is in the one or more configurations of the input variables, one or more such states.

For example, the LLM may not have covered combinations of input parameter alternatives in its output. This is recognized when checking the criterion (especially for completeness), and the LLM is prompted accordingly to complete its output in this regard.

Exemplary embodiment 6 is a method according to any one of exemplary embodiments 1 to 5, wherein requesting the LLM to correct the output comprises requiring the LLM to supplement the possible embodiments for one or more input variables for which its output does not indicate the possible embodiments in full.

For input variables, for example, the LLM may indicate none or not all possibilities for configurations (e.g., values or ranges of values) that these input variables can assume. This is also recognized when checking the criterion (especially for completeness), and the LLM is prompted accordingly to complete its output in this regard.

Exemplary embodiment 7 is a method according to any of the exemplary embodiments 1 to 6, wherein controlling the technical system according to the output or the improved output comprises generating control software from the output or the improved output, and executing the control software by a control device of the technical system.

Exemplary embodiment 8 is a data processing system (in particular a control device or control assembly) which is set up to perform a method according to one of exemplary embodiments 1 to 7.

Exemplary embodiment 9 is a computer program with instructions that, when executed by a processor, cause the processor to carry out a method according to any of exemplary embodiments 1 to 7.

Exemplary embodiment 10 is a computer-readable medium that stores instructions that, when executed by a processor, cause the processor to perform a method according to any of exemplary embodiments 1 to 7.

### BRIEF DESCRIPTION OF THE DRAWINGS

In the drawings, similar reference signs generally refer to the same parts throughout the different views. The drawings are not necessarily to scale, wherein emphasis is instead generally placed on representing the principles of the disclosure. In the following description, various aspects are described with reference to the following drawings.

FIG. 1 shows a vehicle.

FIG. 2 illustrates determining and reviewing a formal description of a behavior of a technical system, according to one embodiment.

FIG. 3 shows a flowchart illustrating a method for controlling a technical system according to one embodiment.

### DETAILED DESCRIPTION

The following detailed description relates to the accompanying drawings, which, for clarification, show specific details and aspects of this disclosure in which the disclosure may be implemented. Other aspects may be used, and structural, logical and electrical changes may be performed without departing from the scope of protection of the disclosure. The various aspects of this disclosure are not necessarily mutually exclusive since some aspects of this disclosure may be combined with one or a plurality of other aspects of this disclosure to form new aspects.

Different examples will be described in more detail in the following.

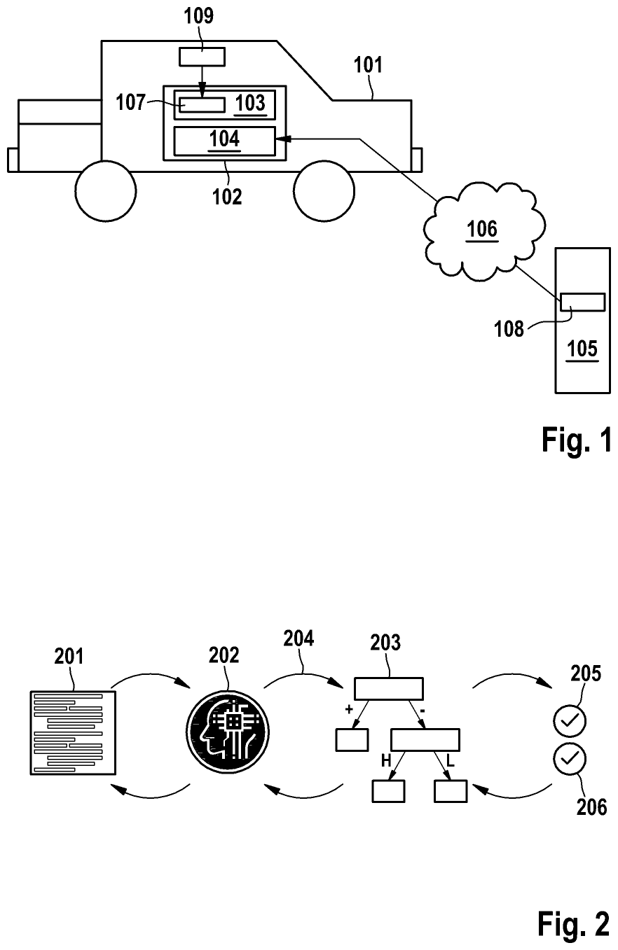

FIG. 1 shows a vehicle 101.

In the example of FIG. 1, a vehicle 101, for example a vehicle like a car or truck, is equipped with a vehicle control device 102 (e.g., an electronic control unit (ECU)).

The vehicle control device 102 has data processing components, e.g., a processor (e.g., a CPU (central processing unit)) 103 and a memory 104 for storing control software 107 (i.e. one or more computer programs) according to which the vehicle control device 102 operates, and data processed by the processor 103. The processor 103 executes the control software 107 (it is therefore shown in FIG. 1 as part of the processor 103).

The control software 107 has instructions that, when executed by the processor, cause the processor 103 to control one or more components of the vehicle 101.

The control software 107 is, for instance, transmitted to the vehicle 101 from a computer system 105, for example via a network 106 (or also using a storage medium such as a memory card). This can also be done during operation (or at least when the vehicle 101 is with the user), because over time the control software 107 is updated to new versions, for example.

Requirements for software (i.e., in particular, a desired behavior, e.g., how a robot device is controlled) such as control software 107 are the starting point of any software development (at least software of relevant size and complexity). Based on the requirements, the architecture of the software is determined, the code is developed, and test cases are written. To achieve this, the requirements must be complete and consistent. Complete means that all relevant use cases are described. Consistent means that there must be no contradiction within the given requirements.

This task becomes more complex the higher the number of requirements. In the case of a fuel cell control unit (e.g., for a fuel cell in the vehicle 101), the set of requirements has more than 4000 requirements for the respective control software. Checking these requirements (and thus the behavior they represent) manually for completeness and consistency is impossible in practice. Without checking for completeness and consistency, however, a significant risk of errors must be accepted.

One way to address the issue of requirement errors (i.e., and thus behavioral description errors) is by using formal specification methods such as Model-Based Systems Engineering (MBSE). In MBSE, domain models—not requirement documents in natural language (NL)—are used as the primary communication means between engineers. Because the specification language is substantially mathematical, the domain models can be tested and verified. There is little room for ambiguity, and the likelihood that a requirement error is not detected is far less.

However, these models must be manually created and maintained by system experts, which is time-consuming. A more recent approach is to use large language models (LLMs) directly for requirements analysis. These approaches lack transparency and have the basic problem that LLM is weak in classical mathematical logic and thus in the review of a formal mathematical model (such as a decision tree) that a software for controlling a robotic device is to follow, as formal mathematical models typically differ greatly from natural language.

According to various embodiments, an approach is provided that allows a number of requirements for a software (and/or for controlling a robotic device) to be checked for completeness and consistency in a highly automated, fast, and reliable manner. According to various embodiments, this includes in particular an automatic formalization of the requirements—hereinafter the textual description of a desired behavior of a technical system and thus software that controls the technical system—so that they can be used as a basis for further steps such as checking, but also, for example, optimization or test case generation.

To this end, the capability of LLMs to work with natural language is combined with the mathematical capability of formal (decision) models, in order to, for example, check requirements for mathematical properties such as completeness or consistency, as will be described below with reference to FIG. 2. For example, the computer system 105 implements an LLM 108.

FIG. 2 illustrates determining and reviewing a formal description of a behavior of a technical system, according to one embodiment.

The SCODE (Systematic Co-Design) Essential Analysis (based on binary decision diagrams, BDD) allows for formalization of system know-how and checking for characteristics such as completeness and consistency. This can occur, for example, during a question-and-answer session with a system expert. According to various embodiments, a specification of requirements, here a textual description 201 of a desired behavior of a technical system, is transmitted to a large language model 202 (i.e., an LLM such as AskBosch, ChatGPT, Llama, etc.), and the know-how included in the specification is formalized via a virtual “question and response session” between the language model 202 and a SCODE tool that generates a SCODE model, in this example a BDD 203 representing the behavior. For this “question-and-answer session”, questions or prompts 204 are derived from the SCODE model 203 (e.g., questions regarding elements missing for completeness of the model 203 or questions regarding overlaps (and thus inconsistencies) in the decision model 203) and forwarded to the language model 202. With the responses of the LLM 202, the SCODE model 203 is updated, and this procedure is repeated until there are no more overlaps and gaps (i.e., a lack of handling possible combinations of input parameters).

For example, the following is performed:
1) Requirements (regarding the behavior of a technical system) 201 that are in natural language are passed via an input prompt to an LLM 202 to define the context.
2) A user defines the technical system in question by indicating the relevant system interfaces to the LLM 202. This information consists of the relevant dimensions (i.e., input parameters) in the SCODE model 203. In addition, the possible different system states (modes) are defined.
   Optionally, the LLM 202 itself can also be used to extract suggestions for the relevant dimensions and/or system states from the requirements 201 as the basis for manual selection and/or completion by the user.
3) The possible discrete values (alternatives) of all dimensions are determined based on the given requirements in natural language by corresponding questions (in one or more prompts) to the LLM (e.g. temperature=“low”, “high”, or “very high”, joint position=“between 0 and 30 degrees”, “more than 30 degrees”). The information resulting from the responses defines the alternatives for each dimension used in the formal model 203. Now the combination space (i.e., the set of modes, wherein each combination of input parameters leads to a particular mode provided the set is complete and the particular mode is unique when the requirements or model is consistent) of the relevant system is defined. All of this can be done automatically by the SCODE tool (i.e., generally the tool that generates and/or verifies the formal model), in particular communication with the LLM 202 via automatically generated prompts.
4) If the system response (i.e., the mode (i.e., state) into which the technical system is to transition) is not defined for a particular input combination, a corresponding question is formulated and forwarded to the LLM. The response is used to update the SCODE model. This (formulation of a prompt with the question and updating of the formal model 203) can be done automatically by the SCODE tool (i.e., generally the tool that generates and/or checks the formal model).
5) Step 4 is repeated until all combinations of the dimensions (i.e., the various alternatives of the input parameters, which may also be ranges of values) are covered.
6) The result is a complete (SCODE) model 203 (relating to the input parameters defined so far) based on the given requirements 201. This model 203 may now be further analyzed (e.g., again through a SCODE tool or in general a review tool) for consistency 205 and completeness 206.
7) If consistency 205 or completeness 206 is not achieved, the model 203, or also the requirements 201, are adjusted. This may require a manual process that requires system know-how (in particular, to adjust requirements 201) and therefore, for example, is not (or at least not completely) performed automatically.
8) If the specification of the requirements 201 and the SCODE model 203 are ultimately complete and consistent, the SCODE model 203 can be used for control, optionally after an optimization of the structure or number of requirements or for implementation of test cases.

The following are examples of input prompts for the LLM 202 and an explanation of how they are used to create a SCODE model 203 from the natural-language requirements 201 for a simple example.

System prompt:
“You are an AI assistant that analyzes natural language requirements. You respond using a JSON object.”

Example of the first prompt, i.e., the prompt with requirements in natural language (Step 1 in the above flow):
“In the following, we describe the requirements of a software system.
The control device shall decide whether the execution of apps in the vehicle is permitted.
If case of doubt, it shall switch to a fallback mode. When the hood of the vehicle is open, the execution of apps shall be disabled. Only if the windshield wiper is not manually switched on, and either it is not raining or the vehicle is stationary shall the execution of apps be allowed.”

Prompt to determine the system mode (Step 2a in the above flow)
“Which system modes differ from each other in their behavior? Use short and meaningful names for the modes. Provide the response in the following JSON format:
{“System Modes”: [{“Mode 1”: “Mode Name”}, {“Mode 2”: “Mode Name”}, . . . ]}”

For the example requirements above, the response of LLM 202 to this prompt looks as follows:
{‘System Modes’: [{‘Mode 1’: ‘Execute Allowed’}, {‘Mode 2’: ‘Execution Disabled’}, {‘Mode 3’: ‘Fallback Mode’}]}
   This means that there are three system modes that can be directly adopted into the SCODE model 203.

Prompt for input signals to make the LLM 202 output input parameters and their possible alternatives if it has not already done so (Steps 2a and 3 in the above flow):
“What are the relevant input signals, and what are their possible values?” Provide the response in the following JSON format:
{“Input Signals”: [{“Signal”: “Signal Name”, “Values”: [List of possible values]}, . . . }

For example, the response of the LLM 202 to this prompt is
{“Input Signals”: [{“Signal”: “Hood status”, “values”: [“Open”, “Closed”]}, {“Signal”: “Windshield wiper status”, “Values”: [“On”, “Off”]}, {“Signal”: “Rain Status”, “Values”: [“Raining”, “Not raining”]}, {“Signal”: “Vehicle Movement Status”, “Values”: [“In motion”, “Stoppage”]}]}

The dimensions (input signals or input parameters) and their alternatives (value list per input signal) are defined for the SCODE model 203. For example, if there is only a single value for an input parameter, the LLM 203 (e.g., via the SCODE tool) is prompted again to refine the alternatives as follows:
“Please refine the possible values of the signal {signal name} based on the relevant values or ranges mentioned in the text.”

If the LLM 202 has provided only input parameters but not their alternatives, they are queried, for example, as follows (Step 3 in the above procedure):
“What possible values does the input signal {Signal Name} have, based on the relevant values or ranges mentioned in the text?” Provide the response in the following JSON format:
{“Input Signals”: [{“Signal”: “Signal Name”, “Values”: [List of possible values]}, . . . }

For each mode, for example, the associated condition (i.e., the combination of input parameters with which it is achieved) is retrieved from the LLM 202 as follows (steps 4 and 5 in the above flow):
“Under what conditions is mode {mode ID} “{mode name}” active?” Wherever possible, use the previously defined signals and values. Provide the answer in JSON format as in this example:
{“Conditions”: [{“Rain Status”: “No rain”, “Vehicle Movement Status”: “standstill”}]} For alternatives, provide multiple lists.”

For Mode 2, for the present example, the following result is obtained:
{“Conditions”: [{“Hood Status”: “Open”}, {“Windshield Wiper Status”: “On”}, {“Rain Status”: “Rain”, “Vehicle Movement Status”: “Movement”}]}

This means that Mode 2 is active when either a) the hood is open, or b) the windscreen wiper is on, or c) it is raining and the vehicle is in motion. The SCODE tool translates this information into three rules for the mode. If alternatives are used in the mode conditions that are not included in the previously captured signal list, the SCODE tool asks the LLM 203 to refine this list based on the missing alternatives, e.g., using the prompt:
“Improve the input signals and values by adding the following input signals and their possible values:”
   wherein in this prompt, an indication of the signals and alternative values in the JSON format follows.

The result (i.e., LLM output in response to this prompt) is used as the new dimension/alternative definition. If alternatives have thereby changed, the mode conditions (and thus the rules for that mode) are re-determined using input prompts as indicated above.

For the review (SCODE analysis) and feedback, the collected dimensions, alternatives, modes and rules are exported to a suitable file format (e.g., a BDD file format), and the SCODE tool performs the SCODE analysis.

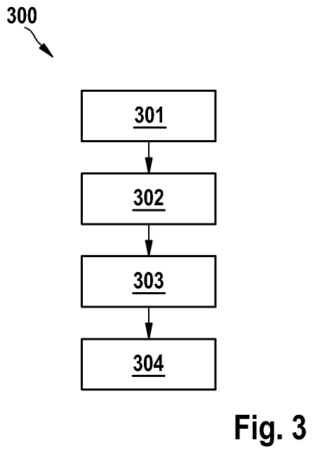

In summary, according to various embodiments, a method as shown in FIG. 3 is provided.

FIG. 3 shows a flowchart 300 illustrating a method for controlling a technical system according to one embodiment.

In 301, a textual description of a (desired) behavior of a technical system is provided to a large language model with the request (in one or more prompts) to output an output with an indication of (possible) states of the technical system and an indication of conditions for the states regarding input parameters of the technical system (i.e., input variables or input signals, also referred to herein as dimensions), which indicate for which configuration of the input variables (i.e., possible alternatives of the input variables or combinations thereof, e.g., “hood open”, “temperature above zero degrees”, etc.) is the technical system in a respective state of the (possible) states.

In 302, it is checked whether the output of the LLM (that it outputs in response to the textual description and the request) satisfies a criterion for completeness and/or consistency (of the states and/or the conditions) and the technical system is controlled according to the output if the output satisfies the criterion.

In 303, in response to the output of the LLM not satisfying the criterion, the LLM is requested once or multiple times to correct the output (i.e., to output an addendum and/or correction for the output, i.e. to add and/or correct the output) until the corrected output satisfies the criterion, and in 304 the technical system is controlled according to the corrected output (i.e., the technical system is controlled according to the output if the output satisfies the criterion and is controlled according to the corrected output if the output does not satisfy the criterion).

The method of FIG. 3 may be performed by a data processing system (e.g., one or a plurality of computers or microcontroller) comprising one or a plurality of data processing units. The term “data processing unit” may be understood to mean any type of entity that enables the processing of data or signals. The data or signals may, for example, be processed according to at least one (i.e., one or more than one) specific function performed by the data processing unit. A data processing unit may comprise or be formed from an analog circuit, a digital circuit, a logic circuit, a microprocessor, a microcontroller, a central processing unit (CPU), a graphics processing unit (GPU), a digital signal processor (DSP), an integrated circuit of a programmable gate array (FPGA) or any combination thereof. Any other way of implementing the respective functions described in more detail here may also be understood as a data processing unit or logic circuit array. One or a plurality of the method steps described in detail here may be carried out (e.g., implemented) by a data processing unit by way of one or a plurality of specific functions performed by the data processing unit.

According to various embodiments, the method is thus, in particular, computer-implemented.

The approach of FIG. 3 is for controlling a technical system, in particular a robotic device. The term “robotic device” can be understood as relating to any technical system (with a mechanical part whose movement is controlled), such as a computer-controlled machine, a vehicle, a household appliance, an electric tool, a manufacturing machine, a personal assistant, or an access control system. For example, control software for the technical system is generated from the output of the LLM (e.g., by the computer system 105) and the technical system (e.g., the vehicle 101) is then controlled accordingly (e.g., by the vehicle control device 102).

Various embodiments may receive and use sensor signals from various sensors as the input variables, such as video, radar, LiDAR, ultrasonics, movement, thermal imaging, etc. (in particular, for controlling, detecting and responding according to the output or the corrected output of the LLM).

What is claimed is:

1. A method for controlling a technical system, comprising:
feeding a textual description of a behavior of a technical system to a large language model (LLM) with the request to output an output indicating states of the technical system and an indication of conditions for the states regarding input parameters of the technical system indicating for which configuration of the input variables is the technical system in a particular state of the states;
checking whether the output of the LLM satisfies a criterion for completeness and/or consistency and controlling the technical system according to the output, if it satisfies the criterion; and
in response to the output of the LLM not satisfying the criterion, requesting the LLM one or more times to rework the output until the reworked output satisfies the criterion, and controlling the technical system according to the reworked output.

2. The method of claim 1, wherein requesting the LLM to rework the output includes supplying a supplement or alteration of the textual description of the behavior of the technical system to the LLM.

3. The method of claim 2, wherein at least one additional behavior rule is added as a supplement to the textual description.

4. The method of claim 1, further comprising generating a discrete decision model, that describes the behavior of the technical system, from the output of the LLM or the improved output of the LLM and checking whether the output or the corrected output satisfies the criterion by examining the discrete decision model and controlling the technical system according to the discrete decision model, when the output or the corrected output satisfies the criterion.

5. The method according to claim 1, wherein requesting the LLM to amend the output comprises requesting the LLM to supplement, for one or more configurations of the input variables for which its output does not indicate a state in which the technical system is located in the one or more configurations of the input variables, one or more such states.

6. The method of claim 1, wherein requesting the LLM to amend the output comprises requesting the LLM to supplement the possible configurations for one or more input variables for which its output does not indicate a full indication of the possible configurations.

7. The method according to claim 1, wherein controlling the technical system according to the output or the improved output comprises generating control software from the output or the improved output and executing the control software by a control way of the technical system.

8. A data processing system configured to carry out the method according to claim 1.

9. A computer program with instructions that, when executed by a processor, cause the processor to carry out the method according to claim 1.

10. A computer-readable medium that stores instructions that, when executed by a processor, cause the processor to carry out the method according to claim 1.
